(19) United States
(12) Patent Application Publication
(10) Pub. No.: US 2003/0035557 A1
(43) Pub. Date: Feb. 20, 2003

(54) Surface acoustic wave device

(76) Inventors: Yuichi Takamine, Kanazawa-shi (JP); Yoichi Sawada, Ishikawa-ken (JP)

Correspondence Address: KEATING & BENNETT LLP, Suite 312, 10400 Eaton Place, Fairfax, VA, 22030, US

(21) Appl. No.: 10/217,417

(22) Filed: Aug. 14, 2002

(30) Foreign Application Priority Data
Aug. 14, 2001 (JP) 2001-246250

(51) Int. Cl. H04R 3/00

(52) U.S. Cl. 381/111

(57) ABSTRACT

A surface acoustic wave device includes at least one interdigital transducer which is disposed on a piezoelectric substrate so as to extend along the surface acoustic wave propagation direction. An input signal terminal and an output signal terminal are also provided on the piezoelectric substrate. The output signal terminal has first and second balanced signal terminals. A capacitance component disposed on the piezoelectric substrate is added to one of the first and second balanced signal terminals. Thus, a surface acoustic wave device having improved balance between the pair of balanced signal terminals is provided.

### BACKGROUND OF THE INVENTION

1. Field of the Invention

The present invention generally relates to surface acoustic wave (SAW) devices used for, for example, as bandpass filters. Particularly, the present invention relates to a SAW device having a pair of balanced signal terminals at the input side and/or output side.

2. Description of the Related Art

In recent years, cellular telephones have become more and more compact and lightweight. For this purpose, the number and size of parts of cellular telephones are being reduced, and the parts are becoming more and more multi-functional.

In view of such a background, a variety of SAW filters having a balance-to-unbalance conversion function, i.e., a so-called “balun” function, which are used in the RF (radio frequency) stage of cellular telephones, have been proposed.

FIG. 23 is a schematic plan view of the electrode configuration of a typical SAW filter having a balance-to-unbalance conversion function.

In the SAW filter shown in FIG. 23, first to third IDTs 601 to 603 are arranged along the SAW propagation direction. Reflectors 604 and 605 are further arranged along the SAW propagation direction so as to sandwich the IDTs 601 to 603 therebetween. The pitch between the IDTs 601 and 602, and the pitch between the IDTs 602 and 603 are 0.75 λI, where λI denotes the wavelength defined by the pitch between electrode fingers of the IDTs 601 to 603. As electrode fingers 609 and 610 at both ends of the IDT 602 become wider, free portions between the IDTs are narrower, thus reducing the loss due to radiation of bulk waves. In FIG. 23, terminals 606 and 607 are balanced signal terminals, and a terminal 608 is an unbalanced signal terminal.

In the SAW filter having a balance-to-unbalance conversion function, it is required that the transmission characteristic in the pass band between the unbalanced signal terminal 608 and the balanced signal terminal 606, and the transmission characteristic in the pass band between the unbalanced signal terminal 608 and the balanced signal terminal 607 be equal in amplitude characteristic and be 180° out of phase. The condition of equal amplitude characteristic is referred to as “amplitude balance”, and the 180° out-of-phase characteristic is referred to as “phase balance”.

When the SAW filter having a balance-to-unbalance conversion function is a three-port device in which, for example, the unbalanced input terminal is a first port and the balanced output terminals are second and third ports, the amplitude balance and the phase balance are defined as follows:

Amplitude Balance=|A|

where A=|201OgS21|−201logS31|.

Phase Balance=|B−180|

where B=|∠S21−∠S31|.

In the above equations, S21 denotes the transfer coefficient from the first port to the second port, and S31 denotes the transfer coefficient from the first port to the third port.

Ideally, in the pass band of the filter, the amplitude balance and the phase balance should be 0 dB and 0 degree, respectively. However, in the configuration shown in FIG. 23, the IDT 602 has an odd number of electrode fingers, and the number of electrode fingers connected to the balanced signal terminal 606 is one more than the number of electrode fingers connected to the balanced signal terminal 607. Thus, a problem has arisen in that the balances are reduced. This problem becomes more noticeable as the center frequency of the filter increases. As a result, a DCS (digital cellular system) or PCS (personal communication system) filter having a center frequency of around 1.9 GHz cannot exhibit sufficient balance.

### SUMMARY OF THE INVENTION

In order to overcome the problems described above, preferred embodiments of the present invention provide a SAW device which solves the above-described problems associated with the typical SAW filter and which has improved balance between a pair of balanced signal terminals.

According to a preferred embodiment of the present invention, a SAW device includes a piezoelectric substrate, at least one IDT arranged on the piezoelectric substrate along a surface acoustic wave propagation direction, an input signal terminal, and an output signal terminal. At least one of the input signal terminal and the output signal terminal has first and second balanced signal terminals. A reactance component is also provided on the piezoelectric substrate, and the reactance component is added to the first balanced signal terminal or the second balanced signal terminal.

Therefore, a reactance component corresponding to a difference in frequency characteristic between the first and second balanced signal terminals is added, thereby effectively improving balance such as an amplitude balance and a phase balance.

Furthermore, the reactance component is provided on the piezoelectric substrate, thereby increasing the out-of-passband attenuation relative to the case where a reactance component is external to the SAW device. In addition, the number of parts of the device does not increase, and the versatility of package is not reduced.

According to another preferred embodiment of the present invention, a SAW filter includes a piezoelectric substrate, at least one IDT arranged on the piezoelectric substrate along a surface acoustic wave propagation direction, an input signal terminal, and an output signal terminal. At least one of the input signal terminal and the output signal terminal has first and second balanced signal terminals. First and second reactance components are also provided on the piezoelectric substrate, and the first and second reactance components are added to the first and second balanced signal terminals, respectively. The first reactance component is preferably different from the second reactance component.

The reactance components to be added to the first and second balanced signal terminals differ depending upon the difference in frequency characteristic between the first and second balanced signal terminals, thereby effectively improving balance such as an amplitude balance and a phase balance.

The reactance components are disposed on the piezoelectric substrate, thereby increasing the out-of-passband attenuation. In addition, the number of parts or the mounting area does not increase, and the versatility of package is not reduced.

The SAW device may include three or more IDTs, and the three or more IDTs define a longitudinally coupled resonator type SAW filter.

Thus, a longitudinally coupled resonator SAW filter having a balance-to-unbalance conversion function, and having improved balance can be achieved.

In another specific preferred embodiment of the present invention, the reactance component is preferably a capacitance component, and is connected in parallel to the balanced signal terminal.

Preferably, the capacitance component has a capacitance electrode disposed on the piezoelectric substrate. This makes it easy to connect a large capacitance component to the balanced signal terminals.

In still another preferred embodiment of the present invention, a duplexer includes the SAW device according to other preferred embodiments of the present invention as a bandpass filter.

The duplexer can therefore have high frequency characteristics with improved balance between the pair of balanced signal terminals.

In still another preferred embodiment of the present invention, a communication device includes the SAW filter according to other preferred embodiments of the present invention as a bandpass filter.

Such a communication device can therefore have high frequency characteristics with improved balance between the pair of balanced signal terminals.

Other features, elements, characteristics and advantages of the present invention will become more apparent from the following detailed description of preferred embodiments with reference to the attached drawings.

### BRIEF DESCRIPTION OF THE DRAWINGS

FIG. 1 is a schematic plan view of the electrode configuration of a SAW device according to a preferred embodiment of the present invention;

FIG. 2 is a schematic plan view of the SAW device shown in FIG. 1, showing how electrodes of the SAW filter are actually arranged on a piezoelectric substrate;

FIG. 3 is a plan view of the electrode configuration of a SAW device in the related art;

FIG. 4 is a graph depicting the frequency-amplitude characteristics of the SAW devices of preferred embodiments of the present invention and the related art;

FIG. 5 is a graph depicting the frequency-versus-S11 VSWR characteristics of the SAW devices of preferred embodiments of the present invention and the related art;

FIG. 6 is a graph depicting the frequency-versus-S22 VSWR characteristics of the SAW devices of preferred embodiments of the present invention and the related art;

FIG. 7 is a graph depicting frequency-versus-amplitude balance plots of the SAW devices of preferred embodiments of the present invention and the related art;

FIG. 8 is a graph depicting frequency-versus-phase balance plots of the SAW devices of preferred embodiments of the present invention and the related art;

FIG. 9 is a graph depicting the frequency-amplitude characteristics of the SAW devices of preferred embodiments of the present invention and the related art;

FIG. 10 is a graph depicting the S11 VSWR characteristics of the SAW devices of preferred embodiments of the present invention and the related art;

FIG. 11 is a graph depicting the S22 VSWR characteristics of the SAW devices of preferred embodiments of the present invention and the related art;

FIG. 12 is a graph depicting frequency-versus-amplitude balance plots of the SAW devices of preferred embodiments of the present invention and the related art;

FIG. 13 is a graph depicting frequency-versus-phase balance plots of the SAW devices of preferred embodiments of the present invention and the related art;

FIG. 14 is a graph depicting the frequency-amplitude characteristics of the SAW devices of preferred embodiments of the present invention and the related art in a broader frequency range;

FIG. 15 is a plan view of a modification of the SAW device shown in FIG. 2, in which a capacitive electrode including an interdigital transducer is provided to define a reactance component;

FIG. 16 is a schematic plan view of the electrode configuration of a modified SAW device having a balance-to-unbalance conversion function according to a preferred embodiment of the present invention;

FIG. 17 is a schematic plan view of the electrode configuration of another modified SAW device having a balance-to-unbalance conversion function according to a preferred embodiment of the present invention;

FIG. 18 is a schematic plan view of the electrode configuration of another modified SAW device having a balance-to-unbalance conversion function according to a preferred embodiment of the present invention;

FIG. 19 is a schematic plan view of the electrode configuration of another modified SAW device having a balance-to-unbalance conversion function according to a preferred embodiment of the present invention;

FIG. 20 is a schematic plan view of the electrode configuration of another modified SAW device having a balance-to-unbalance conversion function according to a preferred embodiment of the present invention;

FIG. 21 is a schematic plan view of the electrode configuration of another modified SAW device having a balance-to-unbalance conversion function according to a preferred embodiment of the present invention;

FIG. 22 is a schematic block diagram of a communication unit having a duplexer that includes the SAW device according to various preferred embodiments of the present invention;

FIG. 23 is a schematic plan view of the electrode configuration of a typical SAW filter; and

FIG. 24 is a schematic block diagram of a SAW device described in the related art.

### DETAILED DESCRIPTION OF PREFERRED EMBODIMENTS

The present invention will become more apparent through description of preferred embodiments of the present invention with reference to the attached drawings.

As described in Japanese Patent Application No. 2001-115642 (Unexamined Japanese Patent Application Publication No. 2002-84165), a SAW device having a balance-to-unbalance conversion function includes a delay line or a reactance component added to one of a pair of balanced signal terminals in order to improve balance. The delay line or reactance component is externally attached to the SAW device, or is introduced into a package that accommodates the SAW elements.

For example, as shown in FIG. 24, a SAW device 401 is provided with a pair of balanced signal terminals 402 and 403, and a single unbalanced signal terminal 404. A reactance component 405 external to the SAW device 401 is coupled to the balanced signal terminal 402.

However, in the case where the reactance component 405 is external to the SAW device 401 and is externally attached to the SAW device 401, the number of parts increases and the required mounting area also increases. If a reactance component is introduced into a package, the optimum reactance varies depending upon the electrode configuration of SAW elements including a piezoelectric substrate and IDTs, thereby reducing the versatility of the package.

The problems associated with the SAW device described in the above-mentioned publication is solved by providing a SAW device according to various preferred embodiments of the present invention.

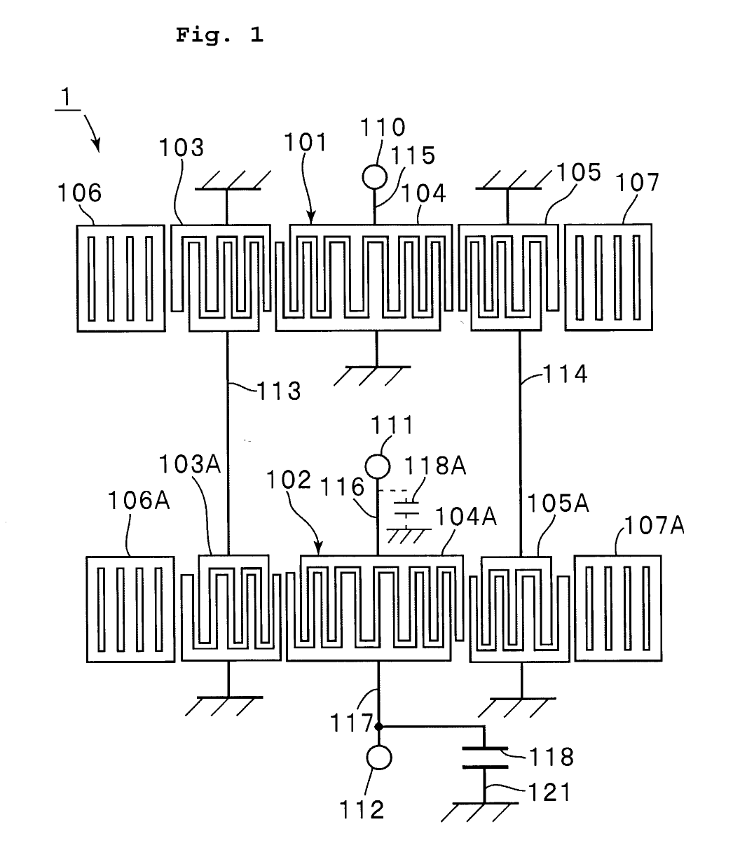

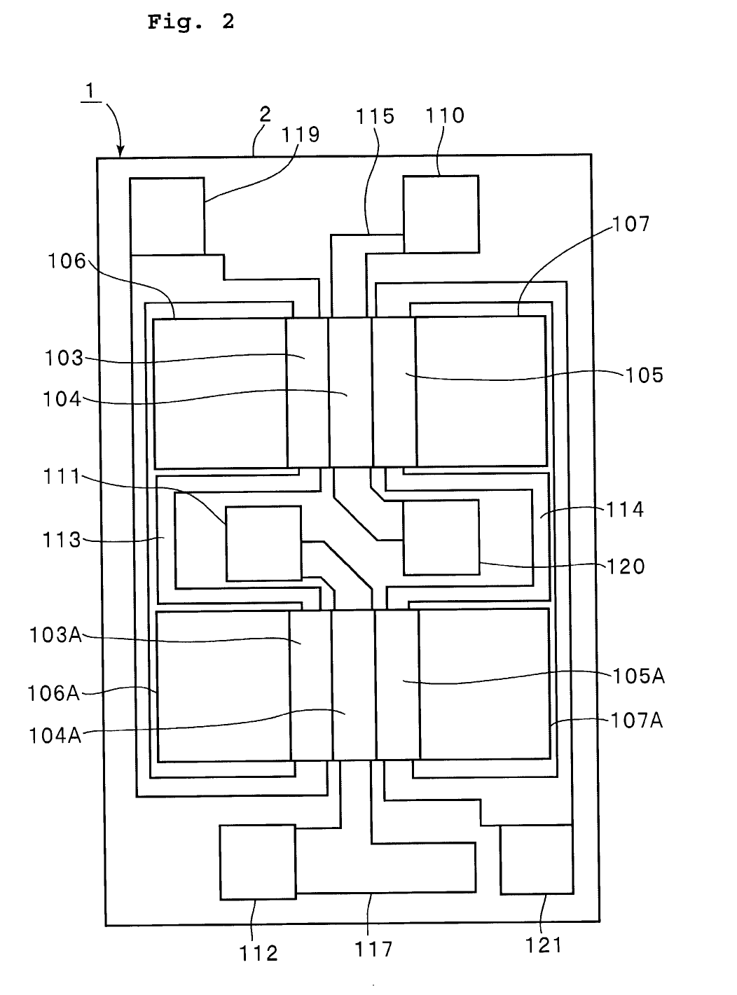

FIG. I is a schematic plan view of the electrode configuration of a SAW device 1 according to a preferred embodiment of the present invention. FIG. 2 is a schematic plan view of the SAW device 1 shown in FIG. 1, showing how electrodes of the SAW device 1 are actually arranged on a piezoelectric substrate.

The SAW device 1 of the present preferred embodiment is preferably an EGSM (extended global system for mobile communications) reception filter; however, the applications of the SAW device 1 according to various preferred embodiments of the present invention are not limited to this type.

As shown in FIG. 2, a piezoelectric substrate 2 is used in the present embodiment. The piezoelectric substrate 2 may be a 40±5° Y-cut X-propagating LiTaO₃ substrate, for example, but other suitable substrates may also be used.

In FIG. 1, the SAW device I of the present preferred embodiment includes longitudinally coupled resonator SAW filters 101 and 102 preferably made of aluminum electrodes.

The SAW filter 101 has three IDTs 103 to 105 arranged along the SAW propagation direction, and reflectors 106 and 107 arranged along the SAW propagation direction to as to sandwich the IDTs 103 to 105 therebetween.

As is apparent from FIG. 1, the pitch between some electrode fingers of the IDT 103 that are adjacent to the IDT 104 is narrower than the pitch between the other electrode fingers of the IDT 103. The pitch between some electrode fingers of the IDT 104 that are adjacent to the IDT 103 and the pitch between some electrode fingers of the IDT 104 that are adjacent to the IDT 105 are narrower than the pitch between the electrode fingers at the center of the IDT 104. The pitch between some electrode fingers of the IDT 105 that are adjacent to the IDT 104 is also narrower than the pitch between the other electrode fingers of the IDT 105.

Accordingly, the IDTs 103 to 105 have narrower-pitch electrode finger portions in which the pitch between the electrode fingers is relatively narrow.

The narrower-pitch electrode finger portions are located in the IDTs 103 to 105 at the region where the IDT 103 is adjacent to the IDT 104 and at the region where the IDT 104 is adjacent to the IDT 105.

The SAW filter 102 is preferably configured in the same manner as the SAW filter 101. Specifically, the SAW filter 102 includes IDTs 103A to 105A having the same configuration as that of the IDTs 103 to 105, respectively, and reflectors 106A and 107A having the same configuration as that of the reflectors 106 and 107, respectively.

The SAW filter 102 is connected to the SAW filter 101 via signal lines 113 and 114. One end of the IDT 103 is connected to one end of the IDT 103A via the signal line 113, and one end of the IDT 105 is connected to one end of the IDT 105A via the signal line 114. The orientation of the IDTs 103 and 105 of the SAW filter 101, and the orientation of the IDTs 103A and 105A of the SAW filter 102 are adjusted so that the phase of a signal propagating on the signal line 113 is reversed with respect to the phase of a signal propagating on the signal line 114.

The SAW device 1 further includes an unbalanced signal terminal 110, a first balanced signal terminal 111, and a second balanced signal terminal 112. The unbalanced signal terminal 110 is connected to the IDT 104 of the SAW filter 101 via a signal line 115. The first and second balanced signal terminals 111 and 112 are connected to the IDT 104A of the SAW filter 102 via signal lines 116 and 117, respectively.

One of the unique features of preferred embodiments of the present embodiment is that a capacitance component 118 disposed on the piezoelectric substrate 2 is connected, as a reactance component, in parallel to the signal line 117 that connects to the second balanced signal terminal 112.

The actual electrode configuration of the SAW device 1 in the present preferred embodiment on the piezoelectric substrate 2 is now described with reference to FIG. 2, in which IDTs, reflectors, and signal lines are designated by the same reference numerals as those in FIG. 1. As shown in FIG. 2, the SAW device 1 further includes ground terminals 119 to 121.

In the present preferred embodiment, the capacitance component 118 is preferably produced by reducing the distance between the signal line 117 and the ground terminal 121.

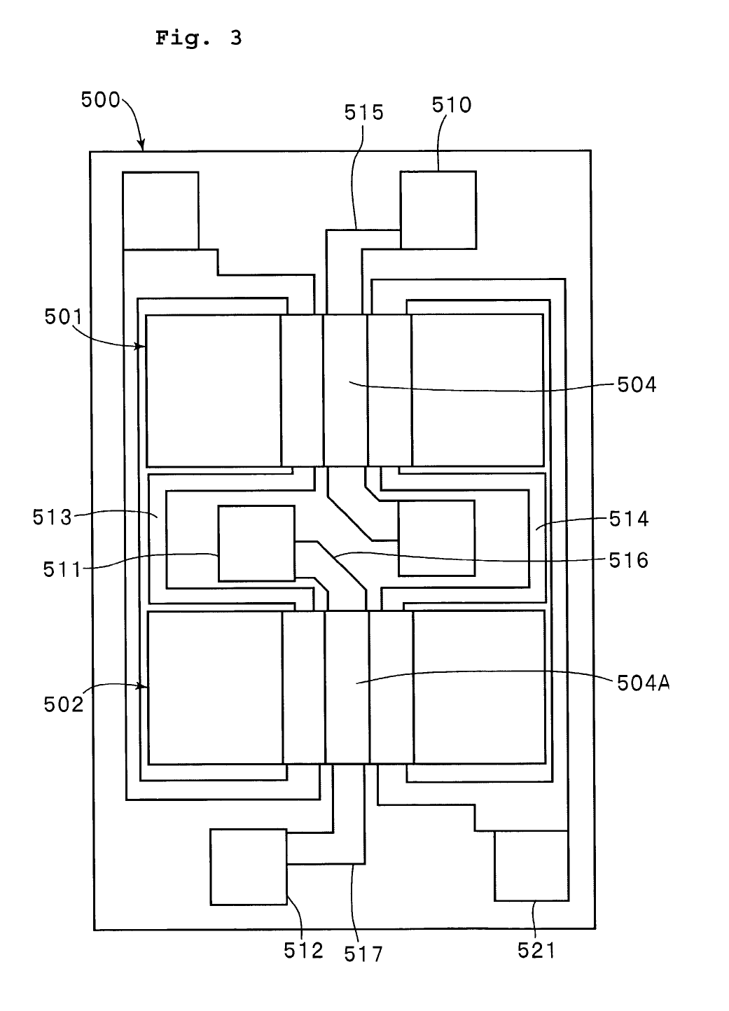

For comparison, the electrode configuration of a SAW filter 500 in the related art having a balance-to-unbalance conversion function is shown in FIG. 3 in a plan view.

Similarly to the SAW device 1 in the present preferred embodiment, the SAW device 500 shown in FIG. 3 includes longitudinally coupled resonator SAW filters 501 and 502. The SAW filters 501 and 502 are configured in the same manner as the SAW filters 101 and 102, respectively. In the same manner as in the SAW device 1 in the present preferred embodiment, in the SAW device 500, the SAW filters 501 and 502 are connected via signal lines 513 and 514. An unbalanced signal terminal 510 is connected to an IDT 504 of the SAW filter 501 via a signal line 515. A first balanced signal terminal 511 is connected to an IDT 504A of the SAW filter 502 via a signal line 516, and a second balanced signal terminal 512 is connected to the IDT 504A via a signal line 517.

In the SAW device 500 in the related art, there is a larger space between the signal line 517 and a ground terminal 521.

Specifically, the SAW device 1 in the present preferred embodiment is configured such that the distance between the signal line 117 and the ground terminal 121 is smaller than the distance between the signal line 517 and the ground terminal 521 in the SAW device 500 in the related art so that the SAW device 1 may provide an electrostatic capacitance of approximately 0.1 pF therebetween.

Thus, in the SAW device 1 in the present preferred embodiment, since a capacitance component is added in parallel to the second balanced signal terminal 112, balance is effectively improved. This advantage is further discussed with reference to an experiment.

In the experiment, the SAW filters 101 and 102 were designed as follows, where the wavelength defined by the pitch between the narrower-pitch electrode fingers is indicated by λI₂, and the wavelength defined by the pitch between the other electrode fingers is indicated by λI₁:

interdigital length W of IDT: 50.0λI₁;

number of electrode fingers of the IDT 103: four narrower-pitch electrode fingers, and 21 remaining electrode fingers

number of electrode fingers of the IDT 104: four narrower-pitch electrode fingers (in each of the narrower-pitch electrode finger portions at both sides), and 28 remaining electrode fingers

number of electrode fingers of the IDT 105: four narrower-pitch electrode fingers, and 21 remaining electrode fingers;

λI₁: 4.20 μm;

λI₂: 3.84 μm;

wavelength λR for reflector: 4.27 μm;

number of electrode fingers of reflector: 100;

pitch between IDTs: 0.512λI₂;

(the pitch between IDTs means the center-to-center distance between an electrode finger of one IDT and an electrode finger of the IDT adjacent thereto)

pitch between IDT and reflector: 0.465 λR

(the pitch between IDT and reflector means the center-to-center distance between an electrode finger of an IDT and an electrode finger of a reflector adjacent to the IDT);

duty for IDT: 0.72;

duty for reflector: 0.52; and

electrode thickness: 0.086 λI₁.

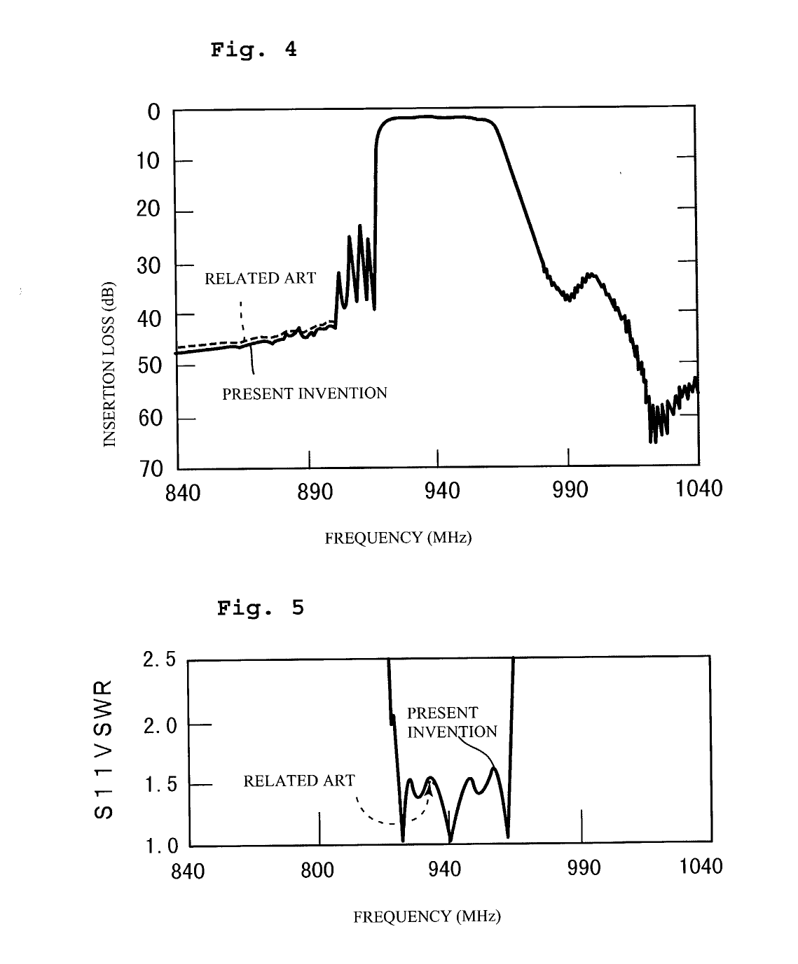

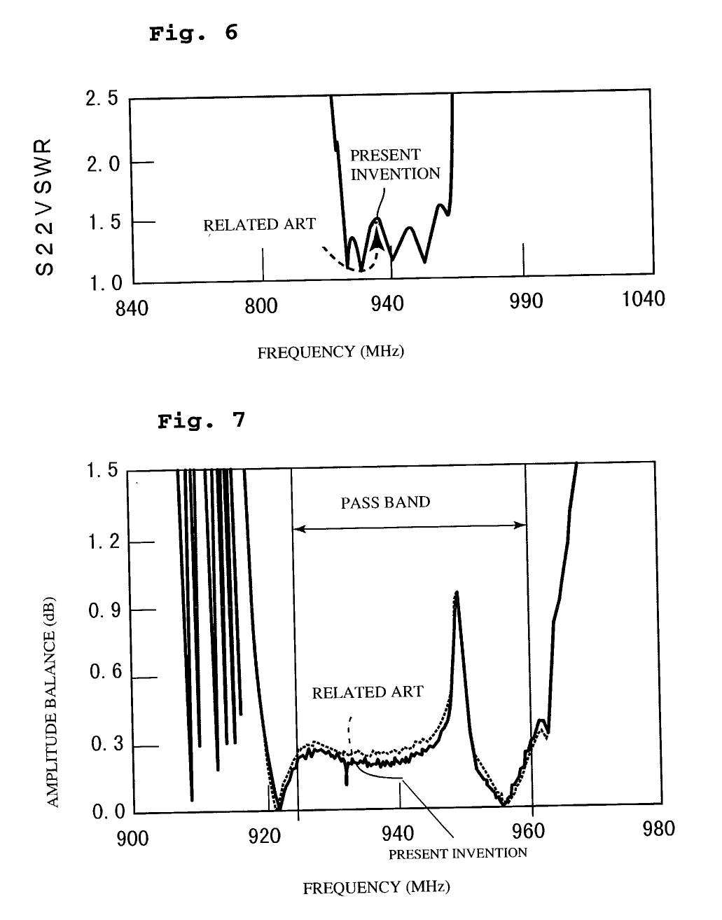

FIG. 4 depicts the frequency-amplitude characteristic of the SAW device 1 in the present preferred embodiment, which is introduced into a package using a flip-chip method. FIGS. 5 and 6 depict the frequency-VSWR (voltage standing wave ratio) characteristics, in which the frequency versus S11 VSWR characteristic is plotted in FIG. 5 and the frequency versus S22 VSWR characteristic is plotted in FIG. 6.

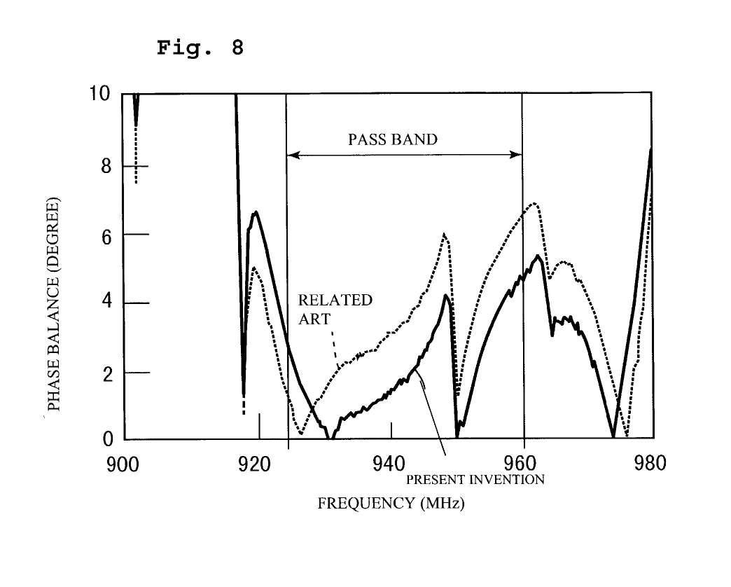

FIGS. 7 and 8 are a frequency-versus-amplitude balance plot and a frequency-versus-phase balance plot, respectively.

Through FIGS. 4 to 6, for comparison, the characteristics of the SAW device 1 in the present preferred embodiment are indicated by solid lines, and the characteristics of the SAW device 500 in the related art are indicated by broken lines.

It is noted that the SAW device 500 in the related art is the same as the SAW device 1 in the present preferred embodiment, except that the signal line 517 is not in close proximity to the ground terminal 522.

As is apparent from FIGS. 4 to 6, the frequency-amplitude characteristic and the VSWR characteristics of the SAW device 1 in the present preferred embodiment are equivalent to those of the SAW device 500 in the related art.

The frequency of the pass band of an EGSM reception filter ranges 925 to 960 MHz. As seen from FIG. 7, the maximum amplitude balance in this frequency range is about 1.0 dB for both the present preferred embodiment and the related art, and there is substantially no difference therebetween. On the other hand, as seen from FIG. 8, the maximum phase balance in that frequency range is about 6.5 degrees for the related art, and is about 4.5 degrees for the present preferred embodiment. In the present preferred embodiment, therefore, the phase balance is improved by about 2 degrees.

According to preferred embodiments of the present invention, the signal line 117 is in close proximity to the ground terminal 121 so that the capacitance component 118 may be connected in parallel to the second balanced signal terminal 112, thereby allowing a phase deviation to be corrected.

A SAW device is provided as a comparative example, in which a capacitance component having the same capacitance as a capacitance component of about 0.1 pF that is added to the SAW device 1 in the present preferred embodiment is not packaged but is externally attached to the SAW device 500 in the related art. This SAW device in the comparative example is equivalent to that described in Japanese Patent Application No. 2001-115642 as previously mentioned.

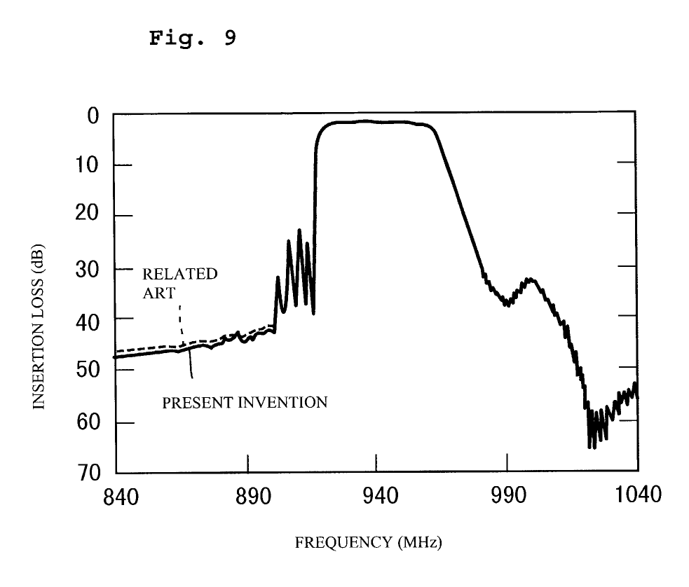

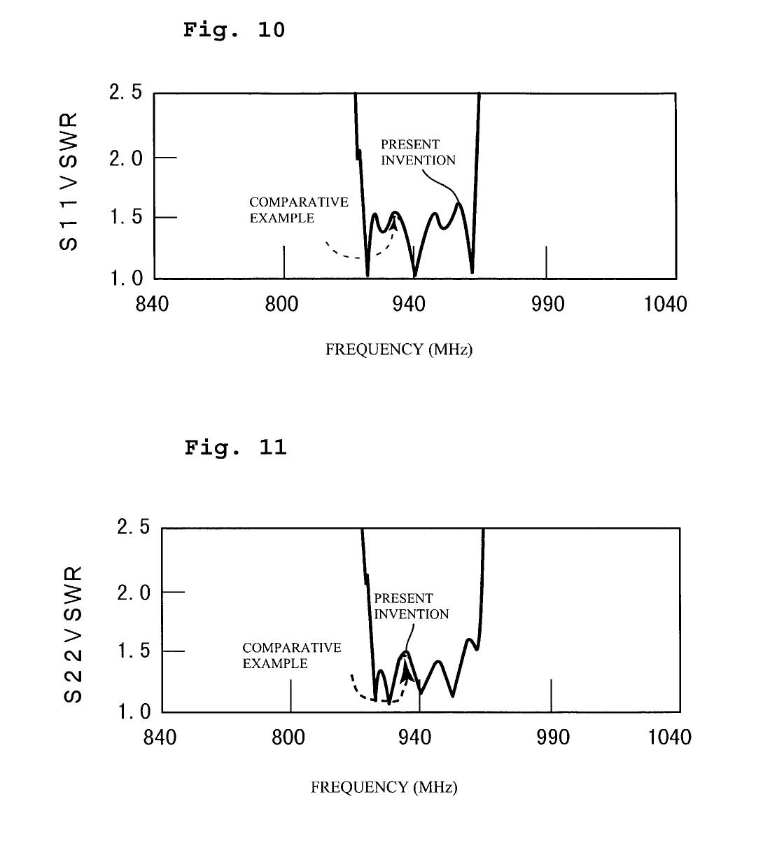

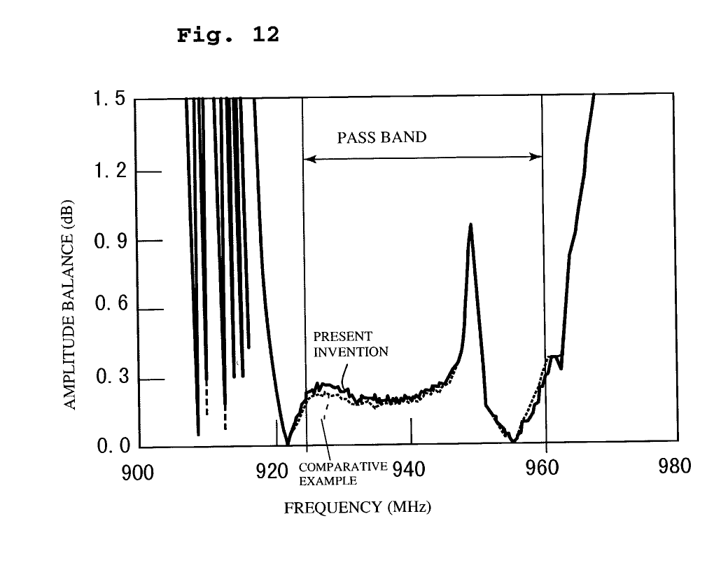

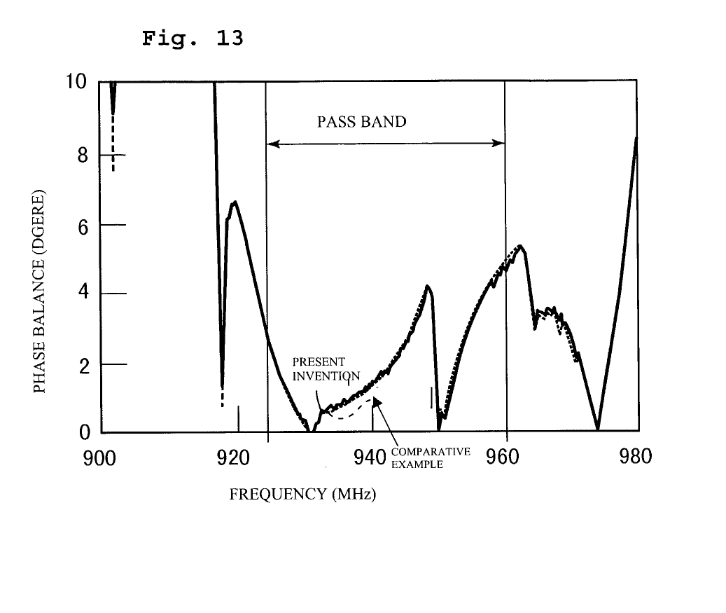

FIG. 9 depicts the frequency-amplitude characteristics for the present preferred embodiment and the comparative example. FIG. 10 depicts the frequency-versus-S11 VSWR characteristics for the present preferred embodiment and the comparative example. FIG. 11 depicts the frequency-versus-S22 VSWR characteristics for the present preferred embodiment and the comparative example. FIG. 12 is a frequency-versus-amplitude balance plot, and FIG. 13 is a frequency-versus-phase balance plot.

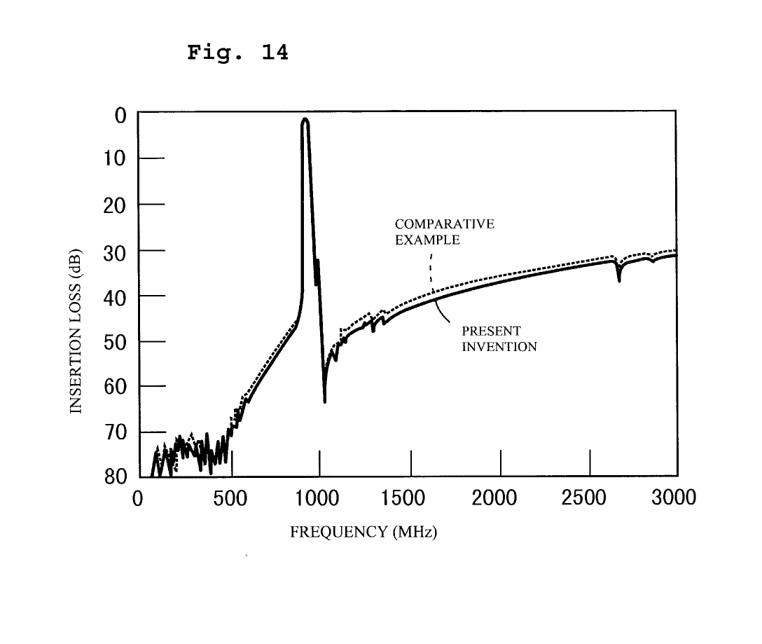

FIG. 14 depicts the frequency-amplitude characteristics for the present preferred embodiment and the comparative example in a broader frequency range. Through FIGS. 9 to 14, the results for the present preferred embodiment are indicated by solid lines, and the results for the comparative example are indicated by broken lines.

As is apparent from FIGS. 9 to 13, the SAW device 1 in the present preferred embodiment exhibits substantially the same characteristics as those of the SAW device in the comparative example in which an electrostatic capacitance of about 0.1 pF is externally attached to the SAW device 500 in the related art. As seen from FIG. 14, however, the out-of-passband attenuation for the present preferred embodiment is about two to three dB greater than that for the comparative example.

According to the present preferred embodiment, therefore, in a SAW device having a balance-to-unbalance conversion function, a capacitance component disposed on a piezoelectric substrate is added in parallel to one of the first and second balanced signal terminals, thereby improving balance and providing a higher out-of-passband attenuation than a SAW device to which a capacitance component is externally attached.

Moreover, since a capacitance component is disposed on a piezoelectric substrate, the mounting area does not increase, and the versatility of the package is not reduced.

Although a capacitance component is coupled to only the second balanced signal terminal 112 in the present preferred embodiment, as indicated by an imaginary line in FIG. 1, an additional capacitance component 118A may be added on the piezoelectric substrate to the first balanced signal terminal 111. In this case, the capacitance components 118A and 118 added to the first and second balanced signal terminals 111 and 112 are different in magnitude, thereby improving balance.

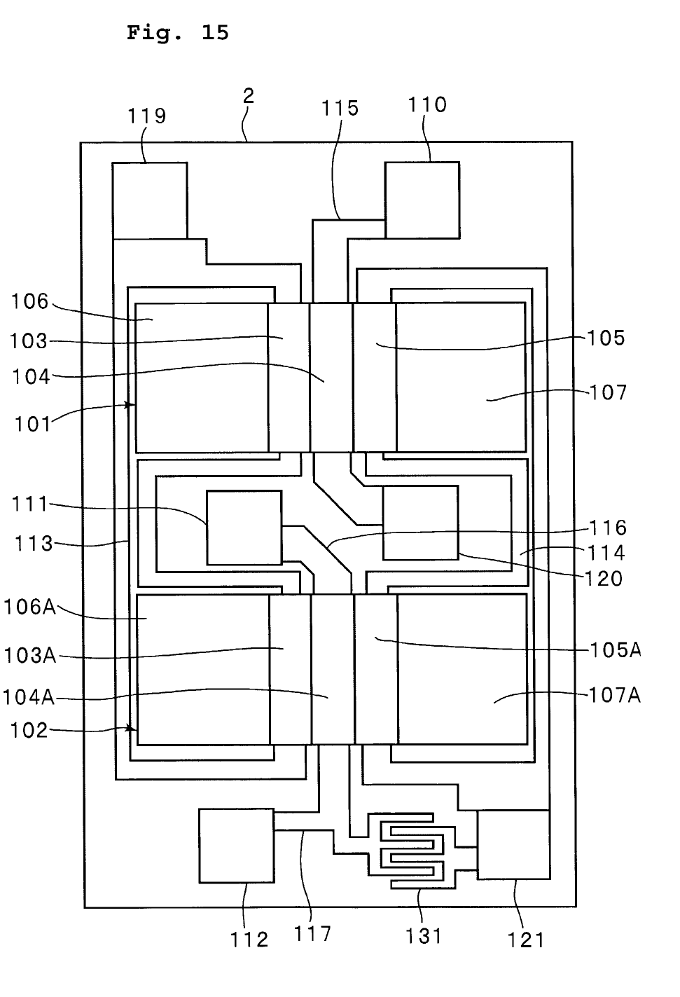

In the illustrated preferred embodiment, the signal line 117 is in close proximity to the ground terminal 121 so as to add a capacitance component. In order to add a greater capacitance component, a capacitive electrode capable of providing a large electrostatic capacitance may be disposed on the piezoelectric substrate. For example, as shown in FIG. 15, a capacitive electrode 131 including an interdigital transducer may be disposed on the piezoelectric substrate 2 to generate a capacitance component.

In the illustrated preferred embodiment, the longitudinally coupled resonator SAW filters 101 and 102 are preferably cascade-connected, and the center IDT 104A of the SAW filter 102 is connected to the first and second balanced signal terminals 111 and 112. However, a SAW device having a balance-to-unbalance conversion function using any other configuration may also be used and is within the scope of the invention.

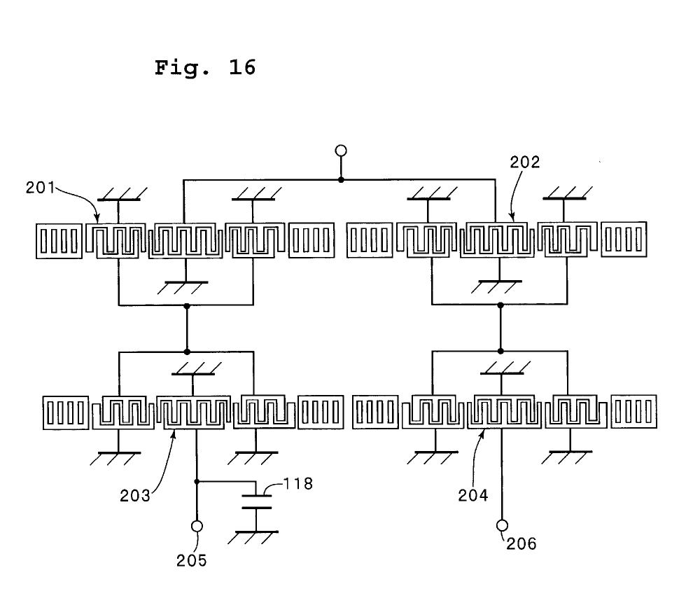

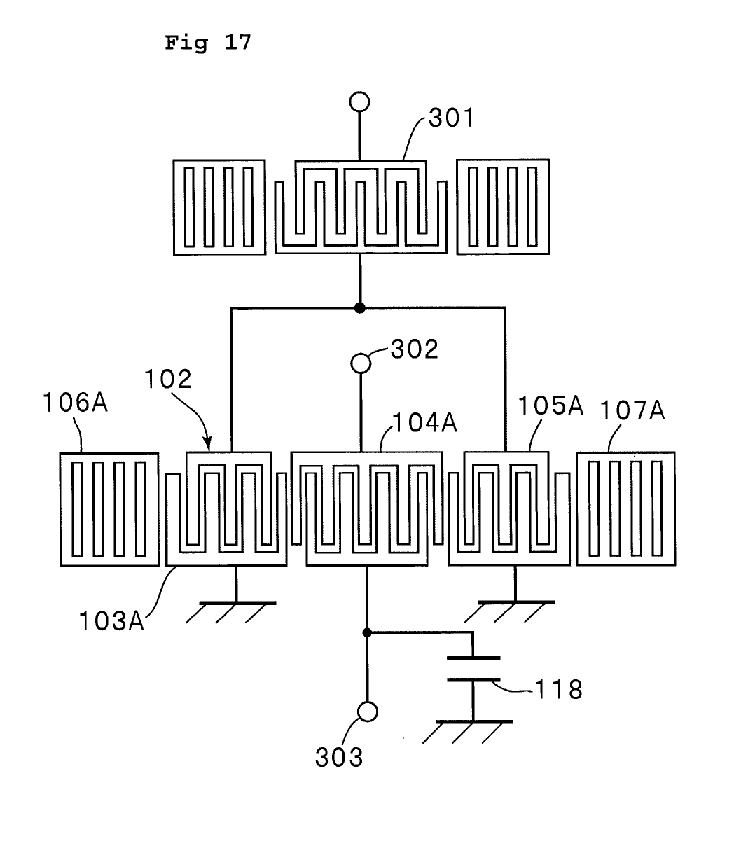

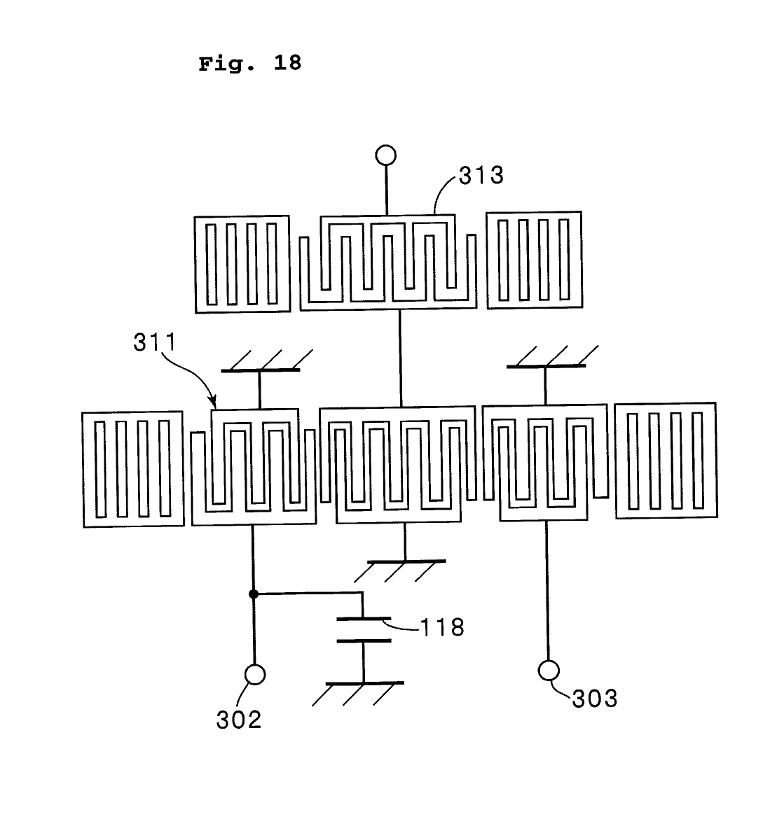

For example, as shown in FIG. 16, a SAW device may be used which includes four longitudinally coupled resonator SAW filters 201 to 204 and which is configured in such a manner that a balanced signal is input/output through balanced signal terminals 205 and 206. Alternatively, as shown in FIG. 17, a SAW device may be used which includes the SAW filter 102 shown in FIG. 1 and a SAW resonator 301 cascade-connected to the SAW filter 102, and which is configured in such a manner that a balanced signal terminal is input/output through balanced signal terminals 302 and 303. The above SAW devices may also be used and are within the scope of the invention.

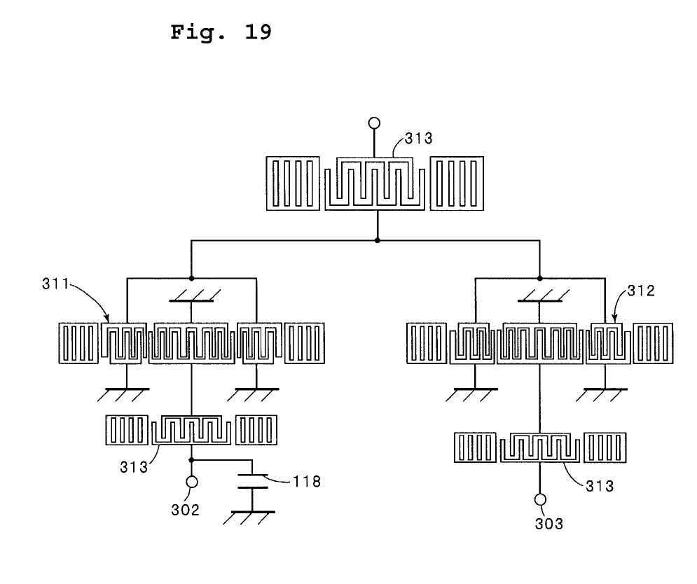

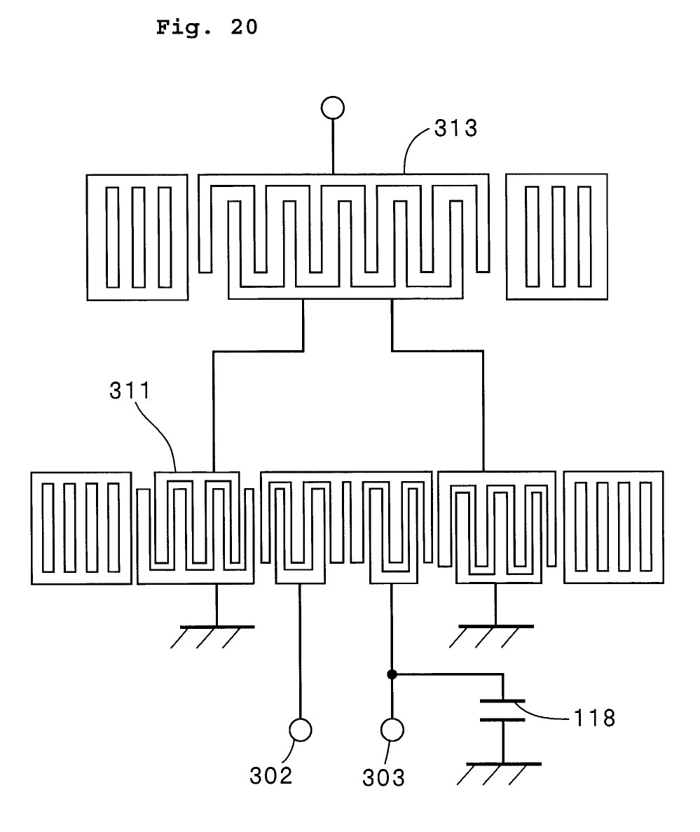

As shown in FIGS. 18 to 20, the present invention may also be applied to a SAW device which includes a SAW resonator 313 connected to at least one of longitudinally coupled resonator SAW filters 311 and 312, and which is configured so that the balanced impedance is higher than the unbalanced impedance.

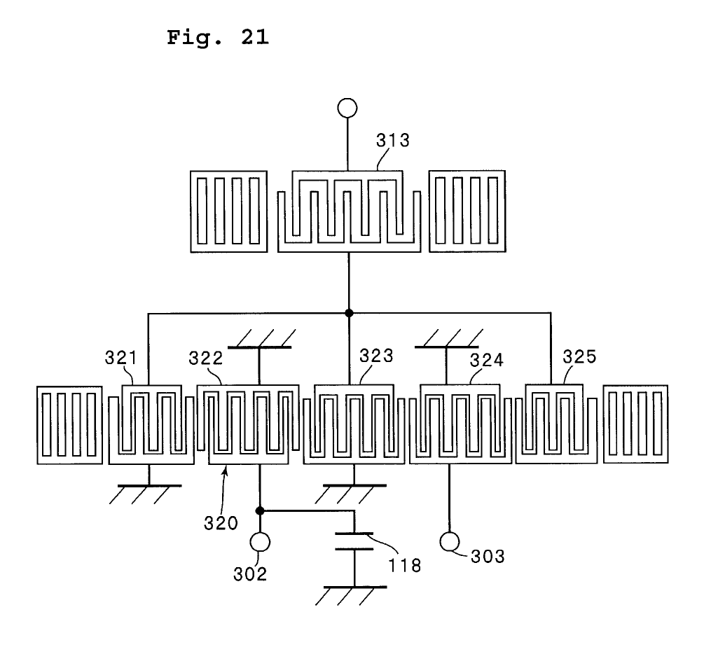

While a longitudinally coupled resonator SAW filter in the illustrated present preferred embodiment has three IDTs, a variety of modifications may be made without departing from the scope of the invention. A SAW filter 320 having five IDTs 321 to 325, as shown in FIG. 21, a SAW filter having more than five IDTs, a SAW filter having two IDTs, etc. may be contemplated.

While a longitudinally coupled resonator SAW filter is used in the illustrated present preferred embodiment, a SAW device having a transversely coupled resonator SAW filter or a transversal SAW filter in order to input/output a balanced signal may also be used and is within the scope of the invention.

The SAW filters 101 and 102 preferably have the same configuration in the illustrated preferred embodiment. However, the present invention is not limited to this form. The SAW filters 101 and 102 may have different design parameters such as the interdigital length.

The present invention may also be applied to various SAW devices using not only a 40±5° Y-cut X-propagating LiTaO₃ substrate but also a variety of piezoelectric substrates including a 64° to 72° Y-cut X-propagating LiNbO₃ substrate, and a 41° Y-cut X-propagating LiNbO₃ substrate, for example.

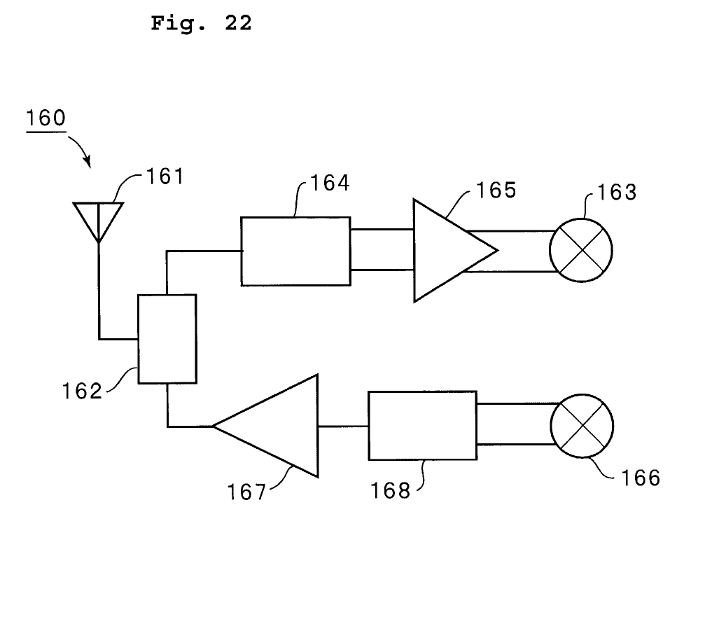

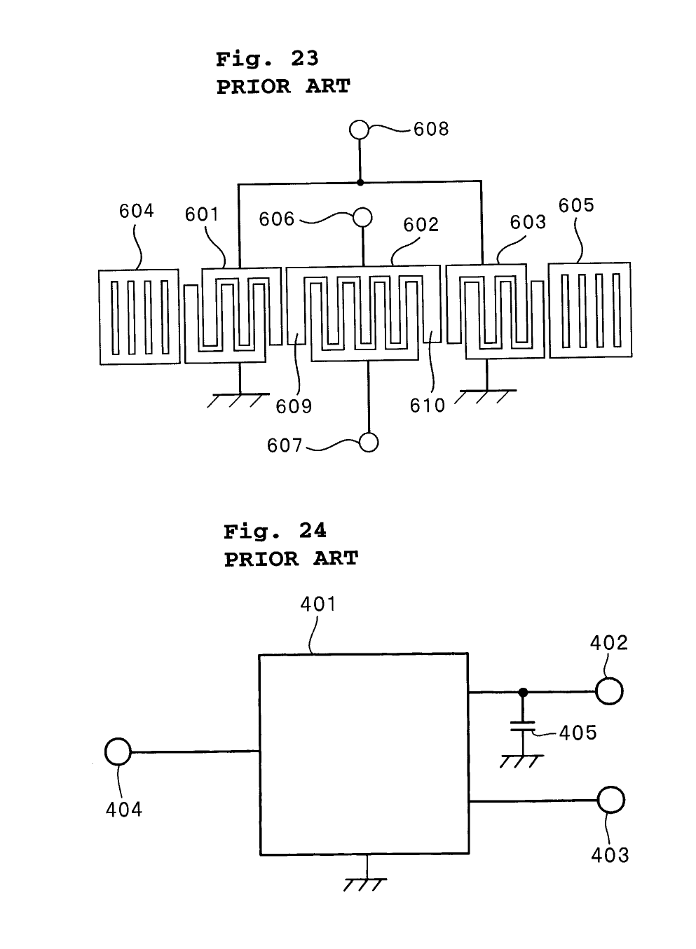

FIG. 22 is a schematic block diagram of a communication unit 160 including the SAW device according to various preferred embodiments of the present invention.

In FIG. 22, a duplexer 162 is connected to an antenna 161. A SAW filter 164 and an amplifier 165 are connected between the duplexer 162 and a receiver mixer 163. An amplifier 167 and a SAW filter 168 are connected between the duplexer 162 and a transmitter mixer 166. If the amplifier 165 supports a balanced signal, a SAW device according to various preferred embodiments of the present invention can be suitably used as the SAW filter 164.

While preferred embodiments of the invention have been described above, it is to be understood that variations and modifications will be apparent to those skilled in the art without departing the scope and spirit of the invention. The scope of the invention, therefore, is to be determined solely by the following claims.

What is claimed is:

1. A surface acoustic wave device comprising:
a piezoelectric substrate;
at least one interdigital transducer arranged on the piezoelectric substrate along a surface acoustic wave propagation direction;
an input signal terminal and an output signal terminal, at least one of the input signal terminal and the output signal terminal having first and second balanced signal terminals; and
a reactance component provided on the piezoelectric substrate, said reactance component being added to at least one of the first balanced signal terminal and the second balanced signal terminal.

2. A surface acoustic wave device according to claim 1, further comprising at least three interdigital transducers, wherein the at least three interdigital transducers define a longitudinally coupled resonator type surface acoustic wave filter.

3. A surface acoustic wave device according to claim 1, wherein the reactance component is a capacitance component, and is connected in parallel to the at least one of the first and second balanced signal terminals.

4. A surface acoustic wave device according to claim 3, wherein the capacitance component has a capacitance electrode disposed on the piezoelectric substrate.

5. A surface acoustic wave device according to claim 1, wherein the surface acoustic wave device is constructed to perform a balance-to-unbalance conversion function.

6. A surface acoustic wave device according to claim 1, including at least two longitudinally coupled surface acoustic wave filters disposed on the piezoelectric substrate.

7. A surface acoustic wave device according to claim 1, wherein the reactance component is provided between the at least one of the first balanced signal terminal and the second balanced signal terminal and a ground terminal.

8. A surface acoustic wave device according to claim 1, wherein the reactance component provides a capacitance of about 0.1 pF.

9. A duplexer comprising the surface acoustic wave device according to claim 1, wherein the surface acoustic wave device defines a bandpass filter.

10. A communication device comprising the surface acoustic wave device according to claim 1, wherein the surface acoustic wave device defines a bandpass filter.

11. A surface acoustic wave filter comprising:
a piezoelectric substrate;
at least one interdigital transducer arranged on the piezoelectric substrate along a surface acoustic wave propagation direction;
an input signal terminal and an output signal terminal, at least one of the input signal terminal and the output signal terminal having first and second balanced signal terminals; and
first and second reactance components provided on the piezoelectric substrate, the first and second reactance components being added to the first and second balanced signal terminals, respectively, wherein the first reactance component is different from the second reactance component.

12. A surface acoustic wave device according to claim 11, further comprising at least three interdigital transducers, wherein the at least three interdigital transducers define a longitudinally coupled resonator type surface acoustic wave filter.

13. A surface acoustic wave device according to claim 1, wherein the reactance components are capacitance components, and are connected in parallel to the first and second balanced signal terminals, respectively.

14. A surface acoustic wave device according to claim 13, wherein the capacitance components have a capacitance electrode disposed on the piezoelectric substrate.

15. A surface acoustic wave device according to claim 11, wherein the surface acoustic wave device is constructed to perform a balance-to-unbalance conversion function.

16. A surface acoustic wave device according to claim 11, including at least two longitudinally coupled surface acoustic wave filters disposed on the piezoelectric substrate.

17. A surface acoustic wave device according to claim 11, wherein the first reactance component is provided between the first balanced signal terminal and a ground terminal and the second reactance component is provided between the second balanced signal terminal and a ground terminal.

18. A surface acoustic wave device according to claim 11, wherein each of the first and second reactance components provides a capacitance of about 0.1 pF.

19. A duplexer comprising the surface acoustic wave device according to claim 11, wherein the surface acoustic wave device defines a bandpass filter.

20. A communication device comprising the surface acoustic wave device according to claim 11, wherein the surface acoustic wave device defines a bandpass filter.
